(19) United States
(12) Patent Application Publication
(10) Pub. No.: US 2015/0222964 A1
(43) Pub. Date: Aug. 6, 2015

(54) WIRELESS SENSING DEVICE AND METHOD

(71) Applicant: ALCATEL LUCENT, Paris (FR)

(72) Inventors: Domhnaill Hernon, Blanchardstown (IE); Christophe Grangeat, Nozay (FR); Markus Berg, Nozay (FR); Ronan Frizzell, Blanchardstown (IE)

(21) Appl. No.: 14/419,529

(22) PCT Filed: Aug. 9, 2013
(86) PCT No.: PCT/EP2013/002405

§ 371 Date: Feb. 4, 2015

(30) Foreign Application Priority Data
Aug. 13, 2012 (EP) 12306000.6

(51) Int. Cl. H04Q 9/00; H04W 84/18

(52) U.S. Cl. CPC H04Q 9/00; H04W 84/18

(57) ABSTRACT

It is disclosed a wireless sensing device comprising a vibration sensor configured to detect a mechanical vibration and to generate an electric signal in response to the mechanical vibration. The device also comprises a transceiver suitable for establishing a wireless connection between the wireless sensing device and a remote device. The transceiver is configured to receive at least a portion of the electric signal from the vibration sensor and, depending on the intensity of electric signal portion, to switch on and transmit a radio signal to the remote device. The radio signal is suitable for triggering a consequent action at the remote device.

### TECHNICAL FIELD

The present invention relates to the field of wireless sensor networks. In particular, the present invention relates to a wireless sensing device for a wireless sensor network, to a method for operating such a device and to a wireless sensor network comprising such a device.

### BACKGROUND ART

As known, a wireless sensor network (briefly, WSN) comprises a number of spatially distributed wireless sensing devices, each device being provided with one or more sensors and one or more short-range wireless transceivers (e.g. Bluetooth transceiver(s)) allowing the node to communicate with the other nodes of the WSN.

The sensors provided at the wireless sensing devices of a WSN are suitable to monitor physical or environmental conditions, such as vibrations, temperature, pressure, light, noise, pollutants, energy, etc., depending on the type of application of the WSN. The most common applications of WSNs include traffic monitoring, domestic monitoring, monitoring of industrial processes or industrial plants, structural monitoring of infrastructures or buildings, and so on.

In a WSN, each wireless sensing device provides data relating to the physical or environmental conditions detected by its own sensor(s). Then, each device may transmit its own data to a central station, possibly through other devices (depending on the topology according to which the devices are arranged). A device may spontaneously transmit its data to the central station or, alternatively, data transmission by a device may be triggered by a query generated by the central station. At the central station, information provided by the various wireless sensing devices are gathered and processed in a centralized way.

Each wireless sensing device typically draws the needed electric power either from the mains or from a local electric power source, such as a battery. The electric power consumption of a wireless sensing device is mainly due to electric power consumed by its sensor(s) and by its wireless transceiver(s).

### SUMMARY OF THE INVENTION

The inventors have noticed that supplying wireless sensing devices by the mains is disadvantageous, in that the WSN provider would need to ask authorization from the local authority distributing electric power for connecting its devices to the mains. Obtaining such authorization may be however a very costly and time-consuming operation.

On the other hand, use of batteries for supplying wireless sensing devices is disadvantageous in that batteries discharge and accordingly have a limited lifetime. When a battery supplying a device discharges, it needs to be replaced. This operation is however very time-consuming (especially in case the WSN comprises several devices spread over a wide area) and accordingly increases the maintenance cost of the WSN. Moreover, accessing a wireless sensing device for replacing its battery may be inconvenient or even impossible, if the location of the device is remote and/or hardly accessible. Moreover, batteries comprise chemicals which may pollute the environment.

In view of the above, the inventors have faced the problem of providing a wireless sensing device (in particular, a wireless vibration sensing device) which overcomes the aforesaid drawbacks.

In particular, it is desired to provide a wireless sensing device (in particular, a wireless vibration sensing device) which comprises an environment-friendly autonomous source of electric power capable of supplying a potentially unlimited amount of electric power, without the need of recharging or replacement for an extended period of time.

Herein reference to the terms “mechanical vibration” is to be understood to relate to a vibration which is caused by the presence or occurrence of a physical phenomenon external to the wireless sensing device. Therefore, intrinsic vibrations which in a real-life devices may be caused by the very operation of the device itself are considered negligible and not encompassed within the meaning of the terms “mechanical vibration” in the context of the present specification.

According to a first aspect, there is provided a wireless sensing device comprising:
a vibration sensor configured to detect a mechanical vibration and to generate an electric signal in response to the mechanical vibration; and
a transceiver suitable for establishing a wireless connection between the wireless sensing device and a remote device,
   wherein the transceiver is configured to receive at least a portion of the electric signal and, depending on an intensity of the at least a portion of the electric signal, to switch on and transmit a radio signal to the remote device.

According to preferred embodiments, the vibration sensor comprises a vibration energy harvester.

More preferably, the vibration energy harvester comprises a housing, a first mass element and a second mass element arranged within the housing, and an energy transducer coupled to the second mass element, the energy transducer being arranged to be activated by a relative motion between the housing and the second mass element, the relative motion being excited by at least a portion of a kinetic energy collisionally transferred from the first mass element to the second mass element.

According to a first embodiment, the sensor is configured to automatically supply the at least a portion of the electric signal to the transceiver.

Preferably, the transceiver is further configured to, when switched on, automatically transmit the radio signal to the remote device.

According to a second embodiment, the wireless sensing device further comprises a control module interposed between the vibration sensor and the transceiver, the control module being configured to check whether the electric signal fulfills one or more predetermined requirements, and to supply the at least a portion of the electric signal to the transceiver if the one or more predetermined requirements are fulfilled.

Preferably, the control module is further configured to instruct the transceiver to transmit the radio signal to the remote device.

Optionally, the transceiver is further configured to include in the radio signal information relating to the electric signal.

According to a second aspect, there is provided a method for operating a wireless sensing device comprising a vibration sensor and a transceiver suitable for establishing a wireless connection between the wireless sensing device and a remote device, the method comprising, at the vibration sensor:
a) at the vibration sensor, detecting a mechanical vibration and generating an electric signal in response to the mechanical vibration; and
b) at the transceiver, receiving at least a portion of the electric signal and, depending on an intensity of the at least a portion of the electric signal, switching on and transmitting a radio signal to the remote device.

According to a first embodiment, step b) comprises automatically receiving the at least a portion of the electric signal to the transceiver as the vibration sensor generates the electric signal.

Preferably, step b) further comprises, at the transceiver, automatically transmitting the radio signal to the remote device as the transceiver switches on.

According to a second embodiment, step b) further comprises, before receiving the at least a portion of the electric signal at the transceiver, checking whether the electric signal fulfills one or more predetermined requirements, and receiving the at least a portion of the electric signal at the transceiver if the one or more predetermined requirements are fulfilled.

Preferably, step b) further comprises instructing the transceiver to transmit the radio signal to the remote device.

Preferably, step b) further comprises including in the radio signal information relating to the electric signal.

According to a third aspect, there is provided a wireless sensor network comprising at least one wireless sensing device as set forth above.

### BRIEF DESCRIPTION OF THE DRAWINGS

The present invention will become clearer by reading the following detailed description, given by way of example and not of limitation, to be read by referring to the accompanying drawings, wherein:

FIG. 1 schematically shows a wireless sensing device according to a first embodiment of the present invention;

FIG. 2 is a flow chart of the operation of the device of FIG. 1;

FIG. 3 schematically shows a wireless sensing device according to a second embodiment of the present invention;

FIG. 4 is a flow chart of the operation of the device of FIG. 3;

FIG. 5 schematically shows a wireless sensor network comprising a number of wireless sensing devices according to the first or second embodiment of the present invention;

FIGS. 6a and 6b relate to an exemplary application of the device of FIG. 1; and

FIGS. 7a and 7b relate to an exemplary application of the device of FIG. 3.

### DETAILED DESCRIPTION OF PREFERRED EMBODIMENTS OF THE INVENTION

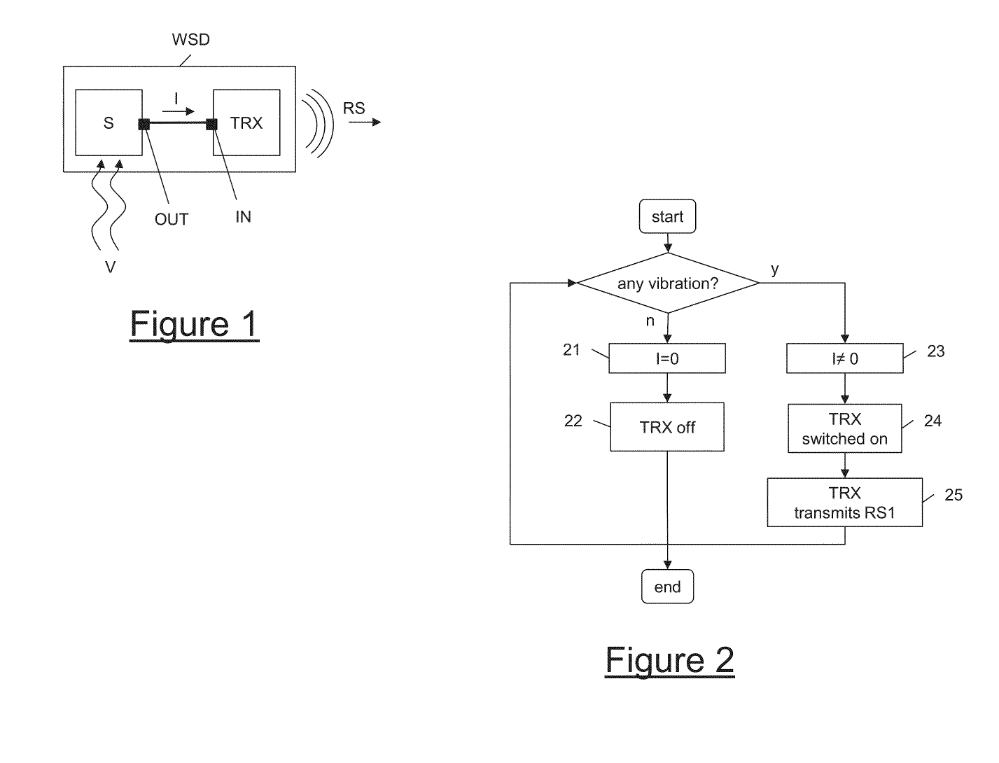

FIG. 1 shows a wireless sensing device WSD according to a first embodiment of the present invention.

The wireless sensing device WSD preferably comprises one or more vibration sensors and one or more wireless transceivers. By way of non limiting example, the device WSD shown in FIG. 1 comprises one vibration sensor S and one short-range wireless transceiver TRX.

The vibration sensor S comprises a sensor configured to detect vibrations using a one-degree-of-freedom based vibration detector and/or a multi-degree-of-freedom based vibration detector. According to particularly preferred embodiments, the vibration sensor S comprises a vibration energy harvester configured to convert a mechanical vibration V into an electric signal I, namely an electric current or an electric voltage. The vibration sensor S has an output OUT through which it emits the electric signal I.

More preferably, the vibration sensor S comprises a vibration energy harvester as described by US 2011/0074162, which is hereby incorporated by reference. Such vibration energy harvester comprises a first mass element of higher mass and a second mass element of lower mass moving ballistically along a straight path to which they are constrained by a low-friction guiding rod (“ballistically” meaning that the motion of the mass elements is dominated by their own momentum, gravity, pseudo-gravity, but is not dominated by friction and applied forces). The mass elements and the guiding rod are contained within a housing to which the guiding rod is fixed. Spring elements are provided to prevent inelastic energy loss in collisions between the mass elements and between each mass element and the housing. Energy transduction is provided by a solenoidal coil concentric with the displacement axis of the mass elements. The second mass element is composed of a permanent magnet. When the second mass element is set in motion, an output voltage is produced by electromagnetic induction. In operation, the housing is in contact with the external source of mechanical disturbance. When the housing is in a state of mechanical agitation, kinetic energy is collisionally transferred from the first mass to the second mass, according to the principle of velocity multiplication. Because the coil is fixed relative to the housing, the relative motion between the second mass element and the housing is equivalent to the relative motion between the second mass element and the coil. This relative motion causes an output voltage to be induced. Such vibration energy harvester is particularly advantageous in that it provides a wide operating frequency bandwidth and is accordingly particularly suitable for real-life applications, where mechanical vibrations may exists over a wide range of frequencies.

The short-range wireless transceiver TRX is preferably configured to implement a wireless connection between the wireless sensing device WSD and a remote device, such as for instance a further wireless sensing device or a remote central station configured to take actions based on information received from the device WSD. The transceiver TRX may comprise for instance a Bluetooth transceiver or a Wi-Fi transceiver. The transceiver TRX preferably comprises an input IN connected to the output OUT of the vibration sensor S, through which it is supplied by the electric signal I emitted by the vibration sensor S, as it will be discussed in detail herein after.

The device WSD may comprise other components, which are not shown in FIG. 1 since they are not relevant to the present description. Furthermore, according to embodiments not shown in the drawings, the device WSD may comprise a voltage actuator (e.g. a DC-DC converter) interposed between the output OUT of the sensor S and the input IN of the transceiver TRX, which is suitable for processing the electric signal I in order to make it suitable for supplying the transceiver TRX.

The operation of the device WSD will be now described in detail, with reference to the flow chart of FIG. 2.

In absence of mechanical vibrations in the environment surrounding the device WSD, the vibration sensor S is not subject to any mechanical vibration, and accordingly it does not generate any electric signal (step 21). The transceiver TRX is therefore not supplied by any electric power and is consequently switched off (step 22).

When a mechanical vibration V arises in the environment surrounding the device WSD, the vibration sensor S converts such a mechanical vibration V into the electric signal I or, in other words, generates the electric signal I in response to the mechanical vibration V (step 23). The vibration sensor S then supplies the electric signal I to the transceiver TRX. If the intensity of the electric signal I is sufficient to power the transceiver TRX, the transceiver TRX switches on (step 24). If the intensity of the electric signal I is not sufficient to power the transceiver TRX, the transceiver TRX remains switched off (this step is not shown in the drawing).

Once switched on, the transceiver TRX preferably automatically transmits a radio signal RS to the above mentioned remote device (step 25). The radio signal RS is indicative of the presence of the mechanical vibration V and is preferably suitable to trigger an appropriate reaction at the remote device. The content of the radio signal RS and the consequent reaction of the remote device depend on the application of the wireless sensor device WSD, as it will be discussed in detail herein after. For instance, the radio signal RS may comprise an alarm message which, upon reception at the remote device, brings the remote device to an alert state, to a waking state or changes its functionality.

Therefore, in the device WSD, the vibration sensor S acts as a local power source for the device itself, and in particular for the transceiver TRX. In absence of mechanical vibrations, the vibration sensor S does not generate any electric power and the device WSD is accordingly switched off. In the presence of mechanical vibrations, the vibration sensor S converts such vibrations into an electric power which may power the transceiver TRX, thereby triggering its switching on and the transmission of the radio signal RS.

Use of the vibration sensor S as a local source of electric power is advantageous in that, differently from batteries, the vibration sensor may provide a potentially unlimited amount of electric power, without any need of recharging or replacement. Maintenance costs due to recharging or replacement of batteries are therefore advantageously avoided. The term “unlimited” as used herein refers to the availability of the power supply at any time of need without the requiring recharging or replacing the source of power as would be the case for example of a battery.

Moreover, the vibration sensor S is an environment-friendly source of energy, since it does not contain any chemical which might pollute the environment.

Furthermore, the power consumption of the device WSD is advantageously minimized, since the device WSD is switched on only when needed, i.e. only when an event occurs (i.e. occurrence of the mechanical vibration V) which shall be reported to the remote device. Otherwise, the device WSD is switched off, and accordingly does not consume any electric power. Besides, the power consumption of the remote device is also advantageously minimized, since the device WSD triggers its switching on or its switching from a sleep mode to a waking mode only when needed, as it will be discussed in further detail herein after.

The device WSD is also advantageously efficient, since the sensing function and the power supplying function are integrated in the same component, namely the vibration sensor S, which detects the mechanical vibration V and, at the same time, converts it into electric power supplying the transceiver TRX.

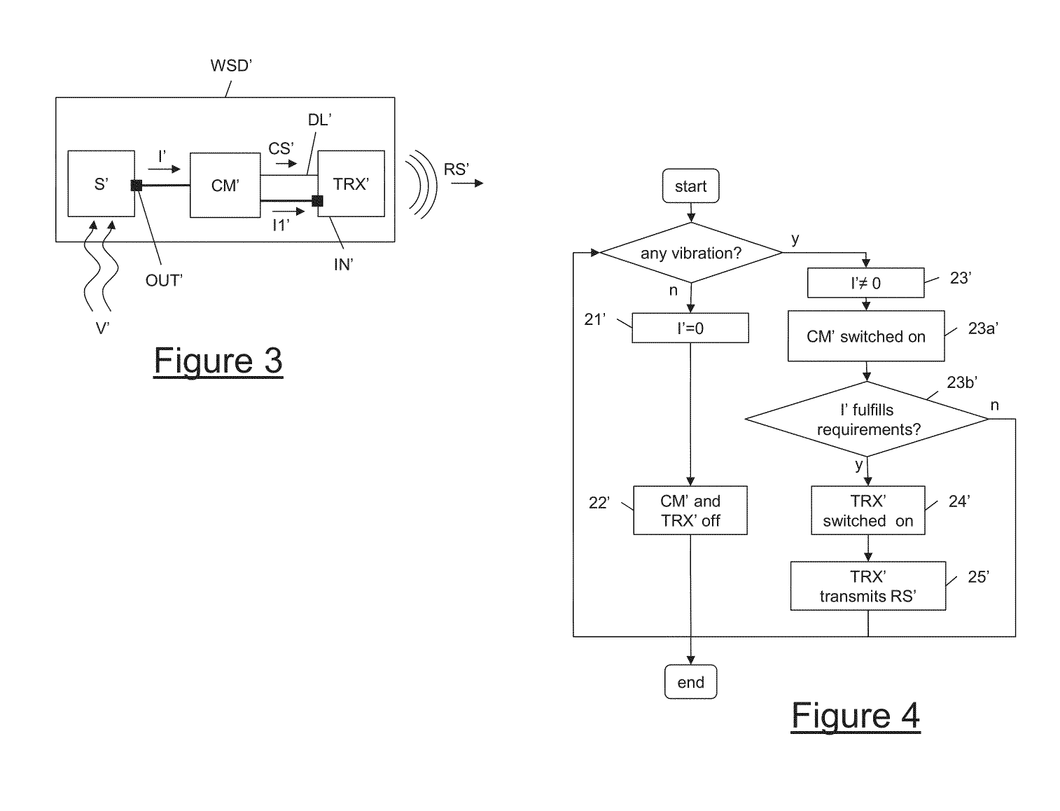

FIG. 3 shows a wireless sensing device WSD′ according to a second embodiment of the present invention.

Similarly to the wireless sensing device WSD of FIG. 1, the wireless sensing device WSD′ preferably comprises one or more vibration sensors and one or more wireless transceivers. By way of non limiting example, also the device WSD′ of FIG. 3 comprises one vibration sensor S′ and one short-range wireless transceiver TRX′.

The vibration sensor S′ and the short-range wireless transceiver TRX′ are substantially similar to the vibration sensor S and the short-range wireless transceiver TRX of FIG. 1. Hence, a detailed description will not be repeated. It is only mentioned that the vibration sensor S′ is configured to convert a mechanical vibration V′ into an electric signal I′ and emit it through its output OUT′. In particular, the vibration sensor S′ preferably comprises a vibration energy harvester based on a one-degree-of-freedom or a multi-degree-of-freedom vibration energy harvester, more preferably the vibration energy harvester described by US 2011/0074162. On the other hand, the transceiver TRX′ comprises an input IN′ through which it may be supplied —under certain conditions—by a portion of the electric signal I′ emitted by the vibration sensor S′, as it will be discussed in detail herein after.

In addition to the vibration sensor S′ and the transceiver TRX′, the device WSD′ also comprises a control module CM′. The control module CM′ is preferably interposed between the vibration sensor S′ and the transceiver TRX′, namely it has an input connected to the output OUT′ of the vibration sensor S′ and an output connected to the input IN′ of the transceiver TRX′. The control module CM′ and the transceiver TRX′ are also reciprocally connected by a data link DL′.

The control module CM′ may comprise one or more hardware components, one or more software components as well hardware components capable of executing software in association with an appropriate software component. The control module CM′ may comprise one or more dedicated processors. Moreover, the control module CM′ may comprise, without limitation, a digital signal processor (DSP) hardware, a network processor, an application specific integrated circuit (ASIC), a field programmable gate array (FPGA), a read-only memory (ROM) for storing software, a random access memory (RAM) and a non volatile storage device.

The operation of the device WSD′ will be now described in detail, with reference to the flow chart of FIG. 4.

In absence of mechanical vibrations in the environment surrounding the device WSD′, the vibration sensor S′ is not subject to any mechanical vibration, and accordingly it does not generate any electric signal (step 21′). The control module CM′ and the transceiver TRX′ are therefore not supplied by any electric power and are consequently switched off (step 22′).

When a mechanical vibration V′ arises in the environment surrounding the device WSD′, the vibration sensor S′ converts such a mechanical vibration V′ into an electric signal I′ or, in other words, generates the electric signal I′ in response to the mechanical vibration V′ (step 23′). The vibration sensor S′ then supplies the electric signal I′ to the control module CM′, which accordingly switches on (step 23a′).

Then, the control module CM′ preferably checks whether the electric signal I′ fulfills one or more predetermined requirements (step 23b′) for triggering switching on of the transceiver TRX′ and transmission of a radio signal.

The predetermined requirement(s) depend on the type of application, as it will be discussed in detail herein after. For instance, the control module CM′ may check whether the intensity of the electric signal I′, which is indicative of the amplitude of the mechanical vibration V′, overcomes a predetermined threshold. Alternatively, the control module CM′ may check whether the frequency spectrum of the electric signal I′, which is indicative of the frequency spectrum of the mechanical vibration V′, fulfills certain shape requirements.

If the one or more predetermined requirements checked at step 23b′ are fulfilled, the control module CM′ preferably supplies a portion I1′ of the electric signal I′ (which is not used for supplying the control module CM′) to the transceiver TRX′. If the intensity of the electric signal portion I1′ is sufficient, the transceiver TRX′ switches on (step 24′). Otherwise, the transceiver TRX′ remains switched off until the intensity of the electric signal portion I1′ becomes sufficient to power it (e.g. due to an increase of the vibration intensity).

When the transceiver TRX′ switches on, the control module CM′ preferably instructs it to transmit a radio signal RS′ to the above mentioned remote device (step 25′). Preferably, step 25′ comprises transmitting a suitable command signal CS′ from the control module CM′ to the transceiver TRX′ via the data link DL′.

The radio signal RS′ is indicative of the fact that the predetermined requirement(s) on the electric signal I′ are fulfilled and is preferably suitable to trigger an appropriate reaction at the remote device. The content of the radio signal RS′ and the consequent reaction of the remote device depend on the application of the wireless sensor device WSD′, as it will be discussed in detail herein after.

For instance, the radio signal RS′ may comprise an alarm message which, upon reception at the remote device, brings the remote device to an alert state, to a waking state or changes its functionality. Alternatively or in addition, the radio signal RS′ may comprise information relating to the electric signal I′ (e.g. frequency spectrum and/or amplitude). Such information relating to the electric signal portion I′ may be provided by the control module CM′ as a result of the processing performed at step 23b′. Further, such information may be stored in a memory included in the device WSD′ until the control module CM′ determines that the transceiver TRX′ is switched on. Then, they are preferably included in the command signal CS′ transmitted from the control module CM′ to the transceiver TRX′.

If the one or more predetermined requirements checked at step 23b′ are not fulfilled, the control module CM′ preferably does not perform any other action. The transceiver TRX′ is not supplied by any electric current and accordingly remains switched off.

Therefore, according to the second embodiment of the present invention, the vibration sensor S′ acts as a local power source for the device WSD′ itself, and in particular for the control module CM′ and the transceiver TRX′. In absence of mechanical vibrations, the vibration sensor S′ does not generate any electric power and the device WSD′ is accordingly switched off. In the presence of mechanical vibrations, the vibration sensor S′ converts such vibrations into an electric power supplying the control module CM′. In turn, the control module CM′ checks whether the predetermined requirement(s) is/are met and, in the affirmative, supplies the transceiver TRX′, thereby triggering its switching on and transmission of the radio signal RS′.

Hence, while according to the first embodiment the transceiver TRX is automatically powered upon detection of any vibration V (provided that the intensity of the electric signal I is sufficient to power it), according to the second embodiment the wireless sensing device WSD′ has the capability of autonomously processing the information relating to the detected vibration V′ and deciding whether to power the transceiver TRX′ based on the results of such processing.

The device WSD′ according to this second embodiment provides the same advantages as the device WSD: potentially unlimited amount of green electric power provided by the vibration sensor, minimization of power consumption of the device WSD′ itself (control module and transceiver being switched on only when needed) and of the remote device, and device efficiency (sensing function and power supplying function being integrated in a same component).

The wireless sensing devices WSD and WSD′ described above may be advantageously included in wireless sensor networks for various applications.

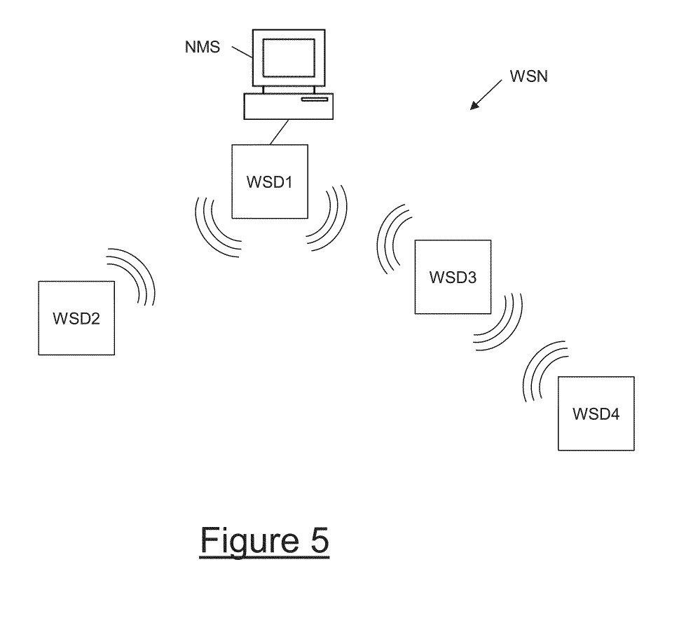

FIG. 5 shows a wireless sensor network WSN comprising a number (four, by way of non-limiting example) wireless sensor devices WSD1, WSD2, WSD3, WSD4. The wireless sensor devices WSD1, WSD2, WSD3, WSD4 may be similar to the device WSD of FIG. 1 or to the device WSD′ of FIG. 3, depending on the type of application. The devices WSD1, WSD2, WSD3, WSD4 are preferably reciprocally interconnected via wireless links according to a tree topology whose root is the device WD1. This is merely exemplary, since the devices WSD1, WSD2, WSD3, WSD4 may be connected according to any known network topology (star, mesh, bus, etc.).

The wireless sensor network WSN also comprises a network management system NMS connected (preferably via a wired link) to the device WSD1.

The device WSD1 preferably acts as a concentrator or gateway, which gathers the information from the other devices WSD2, WSD3, WSD4, optionally performs a processing of the gathered information and forwards them to the network management system NMS. The network management system NMS preferably receives the information from the device WSD1, processes them and performs consequent management actions, such as for instance sending alarms, etc.

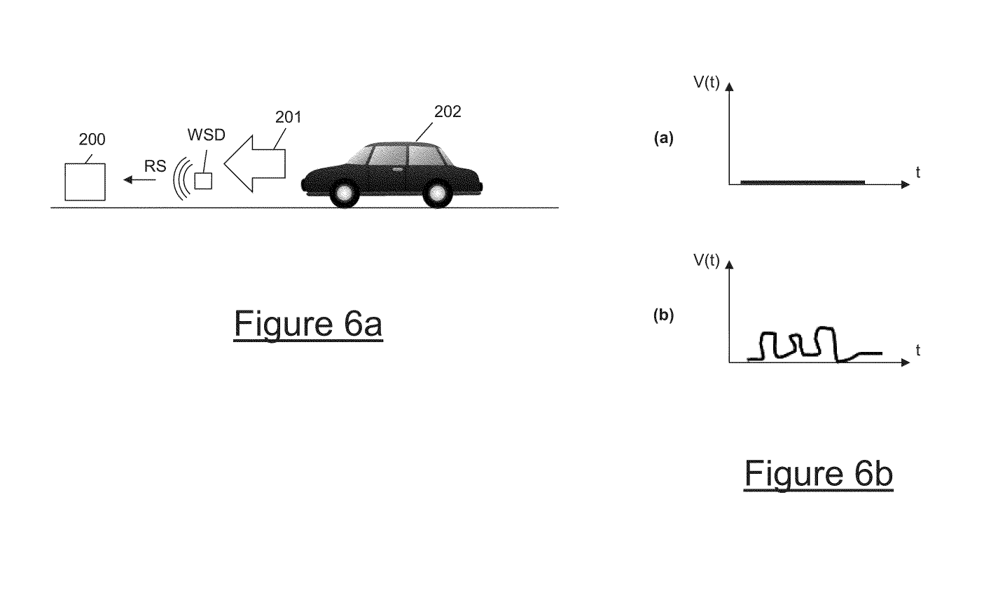

An exemplary application of the device WSD according to the first embodiment of the present invention will be now described with reference to FIGS. 6a and 6b.

FIG. 6a shows a traffic monitoring device 200 located at a side of a road and configured to provide real-time traffic information (such as for instance road congestion or travel times) relating to that road. The traffic monitoring device 200 preferably comprises a wireless transceiver (such as a Bluetooth transceiver) configured to receive information from vehicles passing along the road to be monitored and a processing module configured to process such information.

A wireless vibration sensing device WSD according to the first embodiment of the present invention is preferably located on the road side in proximity of the traffic monitoring device 200. In particular, the device WSD is located before the traffic monitoring device 200 along the progress direction of vehicles (which is shown by the arrow 201 in FIG. 6a). The device WSD may be included in a wireless sensing network configured to collect data relating to different points distributed along the same road or to different roads.

The device WSD is configured to detect the ground vibrations.

In particular, as shown in FIG. 6b, when no vehicle passes along the road close to the device WSD, the electric signal I(t) provided by the vibration sensor S comprised in the device WSD is substantially null, as shown in the upper time diagram (a). The transceiver TRX of the device WSD is accordingly switched off.

When a car 202 passes along the road close to the device WSD, the electric signal I(t) provided by the vibration sensor S has a time-varying intensity related to the time-varying vibration amplitude, as shown in the lower time diagram (b). The electric signal I(i) is supplied to the transceiver TRX of the device WSD, which accordingly switches on and automatically transmits a radio signal RS to the traffic monitoring device 200.

When no vehicle passes along the road, the traffic monitoring device 200 is preferably in a sleep mode. In the sleep mode, only its wireless transceiver is active, whereas its processing module and possible other components are switched off. When the vehicle passes along the road, the traffic monitoring device 200 receives through its wireless transceiver the radio signal RS transmitted by the device WSD and, upon reception of such radio signal, switches from the sleep mode to a waking mode. In the waking mode, all the components (including the processing module) of the device 200 are switched on and process the information received from the vehicle 202.

Hence, the wireless vibration sensing device WSD advantageously allows keeping the traffic monitoring device 200 in sleep mode except when needed, i.e. when a car passes from which information shall be collected. This allows reducing power consumption of the device 200, especially in less frequented roads and at off-peak hours.

In addition or alternatively to the above function of switching the traffic monitoring device 200 from sleep mode to waking mode, the device WSD may also be used for estimating the number of passing vehicles, for switching a speed-camera from sleep mode to waking mode, and so on. Instead of the device WSD, a device WSD′ according to the second embodiment may be provided, which may carry out more sophisticated functions such as determining the type of vehicle (car, bus, truck, etc.), determining whether the weight of a vehicle overcomes a given threshold, and so on.

A further wireless vibration sensing device similar to the device WSD or WSD′ may also be placed on the vehicle 202. Upon detection of the vehicle vibrations, the transceiver of such device WSD switches on and may transmit to the traffic monitoring device 200 a radio signal RS comprising information relating to the vehicle (e.g. an identifier). If multiple devices 200 are distributed along the road, information relating to the vehicle collected by the various devices 200 allows providing detailed information on that vehicle, e.g. the average speed. In addition or alternatively, such device WSD may detect operating conditions of the vehicle (e.g. wheel balance/pressure).

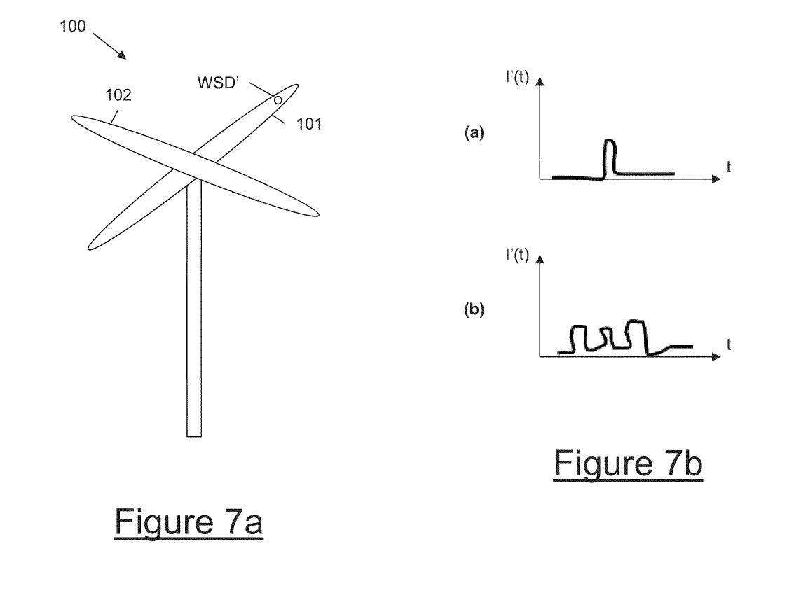

An exemplary application of the device WSD′ according to the second embodiment of the present invention will be now described with reference to FIGS. 7a and 7b.

FIG. 7a shows a wind turbine 100 comprising two turbine blades 101, 102. The wind turbine 100 further comprises a vibration wireless sensing device WSD′ according to the second embodiment of the present invention. The device WSD′ is preferably located at the end of one of the turbine blades 101. The device WSD′ is configured to communicate via wireless with a remote control station (not shown in FIG. 7a). The device WSD′ may be included in a wireless sensing network configured to collect data relating to several wind turbines.

The device WSD′ continuously detects the mechanical vibrations V′ undergone by the turbine blade 101.

As shown in FIG. 7b, when the turbine blade 101 properly operates, the electric signal I′(t) provided by the vibration sensor S′ comprised in the device WSD′ has known predefined shape, which is shown in the upper time diagram (a). If the blade 101 becomes damaged, the electric signal I′(t) provided by the vibration sensor S′ is distorted relative to the known shape of the upper diagram (a), as shown in the lower time diagram (b).

The control module CM′ included in the device WSD′ preferably determines the presence of distortions relative to the known predefined shape of diagram (a) (step 23b′ of the flow chart in FIG. 4). In the absence of distortions, no electric power is supplied to the transceiver TRX′ of the device WSD′, which is accordingly switched off. As a distortion arises, the control module CM′ of the device WSD′ supplies the transceiver TRX′, which accordingly switches on (step 24′ of the flow chart in FIG. 4) and transmits a radio signal RS′ to the remote control station (step 25′ of the flow chart in FIG. 4). The remote control station is accordingly informed of the fact that the turbine blade 101 is damaged. Such information may be advantageously used to predict future failure of the turbine 100.

Use of the device WSD′ in such exemplary application is particularly advantageous, because wind turbines are often located in remote rural areas, where the mains may not be available or not reliable. In case the electric power I′ provided by the vibration sensor S′ exceeds the power demand of the device WSD′, the exceeding electric power may be advantageously merged with the electric power generated by the wind turbine 100.

The wireless sensing devices WSD and WSD′ may be used for several other applications. For instance, they may be used for determining whether the intensity of vibrations to which workers are exposed is compliant with the relevant regulations.

Alternatively, the wireless sensing device WSD or WSD′ may be used for protecting historical buildings, sport arenas, stadiums, etc. from damages due to vibrations. In such case, when vibrations arise or exceed a given threshold, the transceiver of the device WSD or WSD′ transmits to a remote control station a radio signal triggering an emergency call.

Again, the device WSD may be advantageously used as door knocker. When someone knocks the door, the device WSD converts the door vibrations into electric power supplying its wireless transceiver, which switches on and automatically transmits an activation signal to a remote bell placed in the apartment.

In all such applications, the device WSD or WSD′ provides the following advantages: potentially unlimited amount of green electric power provided by the vibration sensor, minimization of power consumption (control module and transceiver being switched on only when needed) and device efficiency (sensing function and power supplying function being integrated in a same component).

1. A wireless sensing device comprising:
a vibration sensor configured to detect a mechanical vibration and to generate an electric signal in response to said mechanical vibration; and
a transceiver suitable for establishing a wireless connection between said wireless sensing device and a remote device, wherein said transceiver is configured to receive at least a portion of said electric signal and, depending on an intensity of said at least a portion of said electric signal, to switch on and transmit a radio signal to said remote device.

2. The wireless sensing device according to claim 1, wherein said vibration sensor comprises a vibration energy harvester.

3. The wireless sensing device according to claim 2, wherein said vibration energy harvester comprises a housing, a first mass element and a second mass element arranged within said housing, and an energy transducer coupled to said second mass element, said energy transducer being arranged to be activated by a relative motion between said housing and said second mass element, said relative motion being excited by at least a portion of a kinetic energy collisionally transferred from said first mass element to said second mass element.

4. The wireless sensing device according to claim 1, wherein said sensor is configured to automatically supply said at least a portion of said electric signal to said transceiver.

5. The wireless sensing device according to claim 4, wherein said transceiver is further configured to, when switched on, automatically transmit said radio signal to said remote device.

6. The wireless sensing device according to claim 1, wherein it further comprises a control module interposed between said vibration sensor and said transceiver, said control module being configured to check whether said electric signal fulfills one or more predetermined requirements, and to supply said at least a portion of said electric signal to said transceiver if said one or more predetermined requirements are fulfilled.

7. The wireless sensing device according to claim 6, wherein said control module is further configured to instruct said transceiver to transmit said radio signal to said remote device.

8. The wireless sensing device according to claim 7, wherein said transceiver is further configured to include in said radio signal information relating to said electric signal.

9. The wireless sensing device according to claim 1 wherein said vibration sensor is configured to acts as a local power source for said device by converting said mechanical vibration into electric power

10. A method for operating a wireless sensing device comprising a vibration sensor and a transceiver suitable for establishing a wireless connection between said wireless sensing device and a remote device, said method comprising:
a) at said vibration sensor, detecting a mechanical vibration and generating an electric signal in response to said mechanical vibration; and
b) at said transceiver, receiving at least a portion of said electric signal and, depending on an intensity of said at least a portion of said electric signal, switching on and transmitting a radio signal to said remote device.

11. The method according to claim 10, wherein said step b) further comprises, before receiving said at least a portion of said electric signal at said transceiver, checking whether said electric signal fulfills one or more predetermined requirements, and receiving said at least a portion of said electric signal at said transceiver if said one or more predetermined requirements are fulfilled.

12. The method according to claim 11, wherein said step b) further comprises instructing said transceiver to transmit said radio signal to said remote device.

13. The method according to claim 12, wherein said step a) further comprises including in said radio signal information relating to said electric signal.

14. The method according to claim 10 wherein said vibration sensor acts as a local power source for said device by converting said mechanical vibration into electric power

15. A wireless sensor network comprising at least one wireless sensing device according to claim 1.
